(19) United States
(12) Patent Application Publication
(10) Pub. No.: US 2026/0097944 A1
(43) Pub. Date: Apr. 9, 2026

(54) METHOD FOR OPERATING A HYDRAULIC SYSTEM OF AN INDUSTRIAL TRUCK HAVING A PLURALITY OF HYDRAULIC PUMPS, AND INDUSTRIAL TRUCK

(71) Applicant: Jungheinrich AG, Hamburg (DE)

(72) Inventors: Thomas STOLTEN, Tremsbuettel (DE); Tim PAGELS, Wakendorf (DE); Jens GLAESKE, Norderstedt (DE)

(73) Assignee: Jungheinrich AG, Hamburg (DE)

(21) Appl. No.: 19/353,989

(22) Filed: Oct. 9, 2025

(30) Foreign Application Priority Data
Oct. 9, 2024 (DE) 10 2024 129 198.2

(51) Int. Cl. B66F 9/22

(52) U.S. Cl. CPC B66F 9/22

(57) ABSTRACT

A method for operating a hydraulic system. The method including providing a delivered volumetric flow of a hydraulic medium for moving at least one hydraulic cylinder by a hydraulic device having at least one hydraulic pump and which at a minimum rotational speed of the at least one hydraulic pump provides a minimum delivered volumetric flow of a hydraulic medium. When reaching a predetermined delivered volumetric flow greater than the minimum delivered volumetric flow of the hydraulic device, a further hydraulic pump is connected having a minimum rotational speed for increasing the delivered volumetric flow of the hydraulic medium when the rotational speed of the at least one hydraulic pump is equal or greater than the minimum rotational speed of the at least one hydraulic pump and the rotational speed of the further hydraulic pump is equal to or greater than the minimum rotational speed of the further hydraulic pump.

### CROSS-REFERENCE TO RELATED APPLICATION

The present application is based upon and claims the benefit of priority from DE 10 2024 129 198.2 filed on Oct. 9, 2024, the entire contents of which is incorporated herein by reference.

### BACKGROUND

The present disclosure relates to a method for operating a hydraulic system, in particular a lifting hydraulic system, of an industrial truck, having a plurality of hydraulic pumps, in particular for lifting a load by a lifting mast. The present disclosure further relates to an industrial truck with a hydraulic system, in particular of a lifting hydraulic system, having a plurality of hydraulic pumps, in particular for lifting a load by a lifting mast.

### PRIOR ART

In the prior art, it is known that industrial trucks are designed with movable lifting devices. For example, a vertically movable load receiving means is lifted by means of a lifting cylinder which is hydraulically connected to a pump, such as for example a hydraulic pump, in order to deliver a pressure medium, such as for example hydraulic oil, to the lifting cylinder during operation, whereby the lifting cylinder and thus the load receiving means are moved.

A method for controlling a lifting hydraulic system on an industrial truck is described, for example, in DE 10 2015 115 817 A1. A method for monitoring the position and controlling hydraulic devices, for example in a forklift truck, is also disclosed in EP 0 798 260 A2.

Industrial trucks, such as for example forklift trucks, frequently have a lifting mast with one or more mast lifting stages which are hydraulically actuated by a mast lifting cylinder or a plurality of mast lifting cylinders. The lifting mast comprises a support mast which is fixedly connected to the vehicle and generally two extending masts, a center mast and an inner mast which are extended from the mast lifting cylinder. A free lift cylinder moves a free lift stage, a load receiving means, for example a fork, being able to be moved thereby along the inner mast of the lifting mast. The free lift stage moves the load receiving means along this mast stage and enables the operator of the industrial truck to move the load receiving means according to the height, without the lifting mast being extended and thus the overall height of the industrial truck changing.

Known forklift trucks have a common hydraulic lowering branch for the mast lift and the free lift, a lowering valve being integrated therein. So that the mast lifting stages and the free lift retract in the desired sequence when lowering the load receiving means, the individual mast lifting stages and the free lift have hydraulic cylinders with different cross sections. If a plurality of mast stages are extended, the mast stage whose effective hydraulic cross section is the smallest overall is retracted first in the load lowering mode of the industrial truck. The greatest hydraulic pressure is applied to this hydraulic cylinder so that it retracts first when the hydraulic pressure drops. Generally this is the uppermost mast lifting stage. If the hydraulic pressure drops further, the mast stages are lowered in series, i.e. in succession. Finally, after the mast stages are fully retracted, the free lift stage is retracted and the load receiving means is lowered.

### SUMMARY

An object is to extend in a simple manner the useful life of a hydraulic system of an industrial truck having a plurality of hydraulic pumps.

Such object can be achieved by a method for operating a hydraulic system, such as a lifting hydraulic system, of an industrial truck, having a plurality of hydraulic pumps, for example, for lifting a load by a lifting mast,
wherein a delivered volumetric flow of the hydraulic medium can be provided for moving at least one hydraulic cylinder by a hydraulic device which has at least one hydraulic pump and which at a minimum rotational speed of the at least one hydraulic pump can provide a minimum delivered volumetric flow of an incompressible hydraulic medium, such as hydraulic fluid,
wherein when reaching a predetermined delivered volumetric flow which is greater than the minimum delivered volumetric flow of the hydraulic device, a further hydraulic pump, which can have its own minimum rotational speed, can be connected for increasing the delivered volumetric flow of the hydraulic medium when the rotational speed of the at least one hydraulic pump of the hydraulic device is equal to or greater than the minimum rotational speed of the at least one hydraulic pump of the hydraulic device and the rotational speed of the further hydraulic pump is equal to or greater than the minimum rotational speed of the further hydraulic pump.

In a hydraulic system of an industrial truck with a plurality of hydraulic pumps, which can be provided for lifting a load by a lifting mast, the hydraulic pumps can be connected as required as a function of the current operating point of the hydraulic system, whereby it is possible to control the hydraulic pumps optimally, such as, in terms of volumetric flow by taking into account the respective minimum rotational speeds of the individual hydraulic pumps. The respective service life or useful life of the hydraulic pump can be extended by observing the minimum rotational speeds of the hydraulic pumps, which can be variable due to the design and/or mode of operation of the hydraulic pumps.

Moreover, with an increase in the delivered volumetric flow an abrupt rise in the delivered volumetric flow can be avoided by the control and the connection, as required, of the further hydraulic pump to the hydraulic pump or the hydraulic pumps of the already operating hydraulic device. Overall, this can result in a gentle increase in the delivered volumetric flow, wherein at the same time the rotational speed of the at least one operated hydraulic pump of the hydraulic device is equal to or greater than the minimum rotational speed of the at least one hydraulic pump of the hydraulic device and the rotational speed of the further hydraulic pump is equal to or greater than the minimum rotational speed of the further connected hydraulic pump.

For example, a noise-optimized hydraulic pump which can provide high volumetric flows can be used as a hydraulic pump of a hydraulic device. The loss in efficiency of the noise-optimized hydraulic pump is small in comparison with the required pump capacity. Moreover, a noise-optimized hydraulic pump has high rotational speeds in comparison with the further hydraulic pump which can be connected or is connected. Typically the rotational speeds of the noise-optimized hydraulic pump can be in the region of 300 revolutions/min and more. These hydraulic pumps can be used for hydraulic functions and operating ranges with average to high rotational speeds and low to high pressure requirements, such as for example for the lifting or for the mast displacement.

The further hydraulic pump which can be connected or is connected is configured, for example, as an efficiency-optimized pump and can be used for functions in which even difficult operating conditions do not result in a significant reduction in the capacity of the hydraulic pump. The efficiency-optimized hydraulic pumps can be used for hydraulic functions and operating ranges at rotational speeds which are lower than the average rotational speeds. Moreover, the efficiency-optimized hydraulic pumps can fulfill average to high pressure requirements, such as for example during tilting or during lateral displacement and for various attachments with corresponding operating ranges. Such hydraulic pumps can be used for operating ranges in which a high degree of accuracy of the hydraulic functions is important, for example for assistance systems or the like, such as for example with a fine positioning of a fork during lifting or during lateral displacement or tilting, wherein the low rotational speeds result in low to moderate noise emissions.

Moreover, the hydraulic device can have exclusively one hydraulic pump, wherein the exclusively one hydraulic pump can have a minimum rotational speed for providing a minimum delivered volumetric flow, wherein when reaching the predetermined delivered volumetric flow which is greater than the minimum delivered volumetric flow of the exclusively one hydraulic pump, the rotational speed of the exclusively one hydraulic pump is equal to or greater than the minimum rotational speed of the exclusively one hydraulic pump and the rotational speed of the further hydraulic pump is equal to or greater than the minimum rotational speed of the further hydraulic pump.

In a further embodiment of the method, the hydraulic device can have a plurality of hydraulic pumps which are connected, such as, in parallel to one another, wherein each of the hydraulic pumps can have a minimum rotational speed for providing a respective minimum delivered volumetric flow of the respective hydraulic pump, wherein when the further hydraulic pump is connected the rotational speeds of the hydraulic pumps of the hydraulic device are respectively equal to or greater than the respective minimum rotational speed of the respective hydraulic pump of the hydraulic device and the rotational speed of the further hydraulic pump is equal to or greater than the minimum rotational speed of the further hydraulic pump.

The one hydraulic pump or at least one hydraulic pump of the operated hydraulic device can be reduced in terms of rotational speed when the further hydraulic pump is to be connected or is connected for increasing the delivered volumetric flow of the hydraulic medium. By reducing the rotational speed of the hydraulic pumps of the hydraulic device a constant delivered volumetric flow can be achieved at the point in time of connecting the further hydraulic pump.

According to a further embodiment of the method, the rotational speed of the at least one hydraulic pump of the hydraulic device can be reduced when the further hydraulic pump is connected or the rotational speeds of the hydraulic pumps of the hydraulic device are reduced when the further hydraulic pump is connected. As a result, the service life or useful life of the operated hydraulic pumps of the hydraulic device can be extended.

The reduced rotational speed of the hydraulic pump or the reduced rotational speeds of the hydraulic pumps can be determined as a function of an available delivered volume of the further hydraulic pump and an additional delivered volume for increasing the delivered volumetric flow.

When the rotational speed of the hydraulic pump of the hydraulic device is reduced or when the rotational speeds of the hydraulic pumps of the hydraulic device are reduced, a constant delivered volumetric flow can be provided when the further hydraulic pump is connected. This can avoid an abrupt rise in the delivered volumetric flow.

A functional speed of the hydraulic system, such as a lifting speed, can be brought about by the hydraulic system, wherein the functional speed of the hydraulic system remains constant when the further hydraulic pump is connected. For example, when the further hydraulic pump is connected, the lifting speed of the hydraulic system can be maintained thereby for moving one or more hydraulic cylinders.

Also provided is a method for operating a hydraulic system, such as a lifting hydraulic system, of an industrial truck, having a plurality of hydraulic pumps, for example, for lifting a load by a lifting mast,
wherein a delivered volumetric flow of the hydraulic medium can be provided for moving at least one hydraulic cylinder by a hydraulic device which has at least one hydraulic pump and which at a minimum rotational speed of the at least one hydraulic pump can provide a minimum delivered volumetric flow of an incompressible hydraulic medium, such as hydraulic fluid,
wherein when reaching a predetermined delivered volumetric flow which is greater than the minimum delivered volumetric flow of the hydraulic device, a further hydraulic pump having a minimum rotational speed can be disconnected for reducing the delivered volumetric flow of the hydraulic medium when the rotational speed of the at least one hydraulic pump of the hydraulic device is equal to or greater than the minimum rotational speed of the at least one hydraulic pump of the hydraulic device.

A hydraulic pump can be disconnected when the delivered volumetric flow of the hydraulic medium is reduced, wherein it is provided that when the further hydraulic pump is disconnected the rotational speed of the at least one hydraulic pump of the hydraulic device is equal to or greater than the minimum rotational speed of the corresponding hydraulic pump of the hydraulic device. As a result, the operated hydraulic pumps are not operated below their own minimum rotational speed.

In that the hydraulic device can have exclusively one hydraulic pump, wherein the exclusively one hydraulic pump can have a minimum rotational speed for providing a minimum delivered volumetric flow, wherein when reaching the predetermined delivered volumetric flow which is greater than the minimum delivered volumetric flow of the exclusively one hydraulic pump the rotational speed of the exclusively one hydraulic pump is equal to or greater than the minimum rotational speed of the exclusively one hydraulic pump.

The hydraulic device can have a plurality of hydraulic pumps which can be connected, such as, in parallel to one another, wherein each of the hydraulic pumps can have a minimum rotational speed for providing a respective minimum delivered volumetric flow of the respective hydraulic pump, wherein when the further hydraulic pump is disconnected the rotational speeds of the hydraulic pumps of the hydraulic device are respectively equal to or greater than the respective minimum rotational speed of the respective hydraulic pump of the hydraulic device.

The rotational speed of the at least one hydraulic pump of the hydraulic device can be increased when the further hydraulic pump is disconnected or the rotational speeds of the hydraulic pumps of the hydraulic device are increased when the further hydraulic pump is disconnected.

The increased rotational speed of the hydraulic pump or the increased rotational speeds of the hydraulic pumps can be determined as a function of a reducible delivered volume of the further hydraulic pump and a smaller delivered volume for reducing the delivered volumetric flow.

When the rotational speed of the hydraulic pump of the hydraulic device is increased or when the rotational speeds of the hydraulic pumps of the hydraulic device are increased, a constant delivered volumetric flow can be provided when the further hydraulic pump is disconnected.

A functional speed of the hydraulic system, such as a lifting speed, can be brought about by the hydraulic system, wherein the functional speed of the hydraulic system remains constant when the further hydraulic pump is disconnected.

The respective minimum rotational speed of the hydraulic pumps of the hydraulic device and the minimum rotational speed of the further hydraulic pump can be dependent on the respective efficiency characteristics of the respective hydraulic pump. An optimal control of the hydraulic pumps can be achieved by taking into account the respective efficiency characteristics.

The hydraulic pumps and the further hydraulic pump can be controlled independently of one another by a control device (controller comprising hardware, such as a CPU, computer, circuit(s) etc.). Due to the independent control of the hydraulic pumps by the control device, such as of the industrial truck, an abrupt rise in the lifting speed, for example of a lifting mast, can be avoided when carrying out the method, wherein the minimum rotational speeds of the respective operated hydraulic pumps are advantageously observed.

Moreover, such object can be achieved by an industrial truck with a hydraulic system, such as a lifting hydraulic system, having a plurality of hydraulic pumps, such as for lifting a load by a lifting mast, wherein the industrial truck is configured to carry out a method as described above. In order to avoid repetition, reference is expressly made to the above embodiments.

### BRIEF DESCRIPTION OF THE DRAWINGS

Further features will become apparent from the description of embodiments together with the claims and the accompanying drawings.

Embodiments may fulfill individual features or a combination of a plurality of features.

The embodiments are described hereinafter without limiting the general inventive idea by way of exemplary embodiments with reference to the drawings, wherein reference is expressly made to the drawings relative to all of the details which are not explained in more detail in the text. In the drawings:

FIG. 1 illustrates schematically a circuit diagram of a hydraulic system of an industrial truck;

FIG. 2 illustrates schematically time diagrams for rotational speeds and the volumetric flow of a hydraulic system; and

FIG. 3 illustrates schematically a flow diagram of a control of the hydraulic system.

Elements and/or parts which are respectively the same or similar are provided with the same reference numerals in the drawings so that in each case a further description is dispensed with.

### DETAILED DESCRIPTION

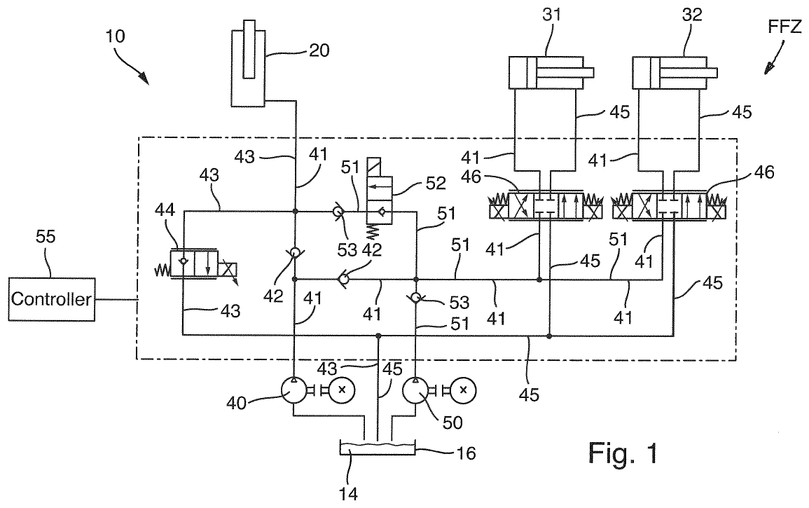

FIG. 1 shows in a schematic view a hydraulic system 10 for an industrial truck FFZ indicated schematically. The hydraulic system 10 has a lifting cylinder 20 for a lifting frame and two hydraulic cylinders 31, 32. A fork of a lifting frame is tilted and/or a mast is displaced by the hydraulic cylinders 31, 32, for example.

The lifting cylinder 20 and the hydraulic cylinders 31, 32 are supplied with a hydraulic fluid 14 from a storage vessel 16, wherein the hydraulic fluid is returned again therein. To this end, for example, a noise-optimized hydraulic pump 40 is provided in order to remove the hydraulic fluid 14 from the storage vessel 16 and to supply it via a supply line 41 and to the lifting cylinders 20 and to the hydraulic cylinders 31, 32. In each case, corresponding check valves 42 are arranged in the respective supply line 41 for the pressure cylinder 20 and the hydraulic cylinders 31, 32.

Hydraulic fluid is fed back from the lifting cylinder 20 via the return line 43 into the storage vessel 16. An actuatable 2/2-way valve 44 is provided in the return line 43.

In each case, actuatable 4/3-way valves 46 are arranged in the supply line 41 for the two hydraulic cylinders 31, 32. The hydraulic fluid from the hydraulic cylinders 31, 32 is returned via return lines 45 into the storage vessel.

Depending on the position of the 4/3-way valves 46 the lines 41 and 45 between the respective hydraulic cylinder 31, 32 and the 4/3-way valve 46 connected thereto are correspondingly employed or used as a supply line or as a return line for the hydraulic fluid.

In addition to the hydraulic pump 40, a second, for example, efficiency-optimized, hydraulic pump 50 is provided, said second hydraulic pump being connected in addition to the first hydraulic pump 40 when the rotational speed of the hydraulic pump 40 is equal to or greater than its minimum rotational speed and at the same time the rotational speed of the second hydraulic pump 50 is equal to or greater than the minimum rotational speed of the hydraulic pump 50. As a result, a control of the two hydraulic pumps 40, 50 which is optimal in terms of volumetric flow is achieved by taking into account their respective minimum rotational speeds. The useful life or service life of the hydraulic pumps is extended by observing the minimum rotational speeds of the hydraulic pumps 40, 50.

A supply line 51 is provided in order to remove hydraulic fluid 14 from the storage vessel 16 when connecting the second hydraulic pump 50 and to supply the hydraulic fluid to the lifting cylinder 20 and the hydraulic cylinders 31, 32, wherein a 2/2-way valve 52 is provided when supplying the hydraulic fluid to the lifting cylinder 20. Moreover, a check valve 53 is respectively arranged upstream and downstream of the 2/2-way valve 52 in the supply line 51, relative to the flow direction of the hydraulic fluid in the supply line 51.

A control device (controller 55) of the industrial truck FFZ is provided for controlling the hydraulic pumps 40, 50 and for actuating the control valves 44, 46 and 52, in order to connect or to control the hydraulic pumps and the control valves according to requirements.

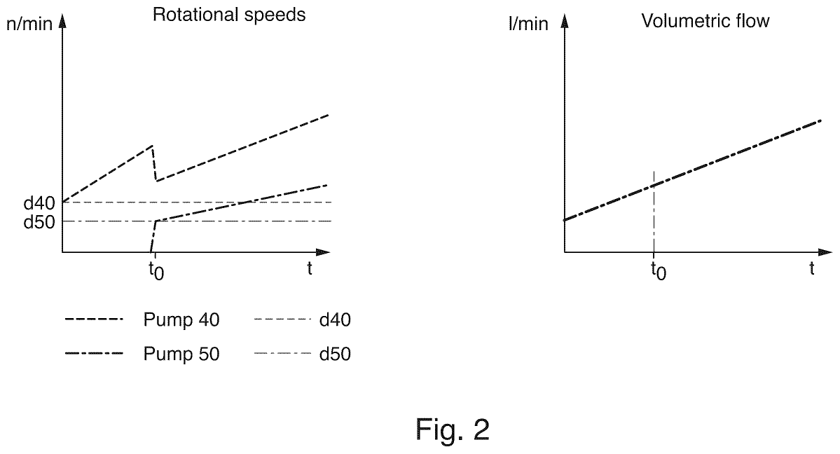

In the right-hand time diagram, the time profile of the rotational speeds of the hydraulic pumps 40, 50 in one embodiment is shown schematically in the view of FIG. 2. In the right-hand time diagram, the linear rise in the volumetric flow is shown schematically.

Initially, only the hydraulic pump 40 is connected in at the start, while the second hydraulic pump 50 is still disconnected. The hydraulic pump 40 has a minimum rotational speed d40. The rotational speed of the hydraulic pump 40 is increased when the requirement of the volumetric flow becomes greater. If at the time to the volumetric flow exceeds a predetermined value, the rotational speed of the hydraulic pump 40 is reduced and at the same time the second hydraulic pump 50 is connected in. The hydraulic pump 50 has a minimum rotational speed d50, wherein the hydraulic pump 50, when connected, in addition to the already operated hydraulic pump 40 has a rotational speed which is equal to or above the minimum rotational speed d50. The rotational speed of the first hydraulic pump 40 is also equal to or greater than its minimum rotational speed d40.

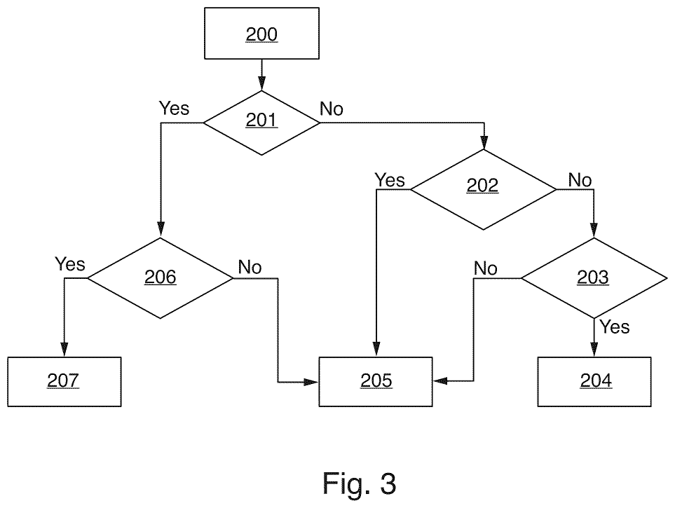

FIG. 3 shows schematically a flow diagram for the operation of an industrial truck with a functional requirement 200 for the hydraulic system with a plurality of hydraulic cylinders. The functional requirement can be the function of lifting a lifting mast and/or a secondary function of the hydraulic system relating to the functional requirement, such as for example adjusting the fork tilt, etc.

With the functional requirement 200, in the following step 201 it is queried whether a lifting function is to be carried out, for example of a lifting mast. In the case that no lifting function are to be carried out, in the following step 202 it is queried whether a secondary function is to be carried out by, for example, a hydraulic cylinder 31, 32 (see FIG. 1). The secondary function can be, for example, a mast displacement. If no secondary function is to be implemented in step 202, in the following query in step 203 it is queried whether the rotational speed of the hydraulic pump 40 is greater than/equal to its minimum rotational speed d40 and whether the rotational speed of the hydraulic pump 50 is equal to or greater than its minimum rotational speed d50. If the first condition is fulfilled, the hydraulic pump 40 is activated in step 204, while the hydraulic pump 50 is disconnected. If the second condition is fulfilled, in step 205 the, for example, efficiency-optimized, hydraulic pump 50 is connected in, while the other hydraulic pump 40 is disconnected.

In the case that a secondary function of the hydraulic system is to be carried out in step 202, the hydraulic pump 50 is activated.

If, after the query in step 201, a lifting function is to be implemented by the hydraulic system, in the following query 206 it is queried whether the rotational speed of the hydraulic pump 40 is greater than/equal to the minimum rotational speed d40 and whether the rotational speed of the hydraulic pump 50 is equal to or greater than its minimum rotational speed d50. If the two conditions are fulfilled, the two hydraulic pumps 40, 50 are activated in step 207. Otherwise, in step 205 only the hydraulic pump 50 is connected in.

While there has been shown and described what is considered to be embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

### LIST OF REFERENCE NUMBERS

10 Hydraulic system
14 Hydraulic fluid
16 Storage vessel
20 Lifting cylinder
31, 31 Hydraulic cylinder
40 Hydraulic pump
41 Supply line
42 Check valve
43 Return line
44 2/2-way valve
45 Return line
46 4/3-way valve
50 Hydraulic pump
51 Supply line
52 2/2-way valve
53 Check valve
55 Controller
200 Functional requirement
201 Step
202 Step
203 Step
204 Step
205 Step
206 Query
207 Step
FFZ Industrial truck

What is claimed is:

1. A method for operating a hydraulic system, the method comprising:
providing a delivered volumetric flow of a hydraulic medium for moving at least one hydraulic cylinder by a hydraulic device which has at least one hydraulic pump and which at a minimum rotational speed of the at least one hydraulic pump provides a minimum delivered volumetric flow of a hydraulic medium,
wherein when reaching a predetermined delivered volumetric flow which is greater than the minimum delivered volumetric flow of the hydraulic device, connecting a further hydraulic pump having a minimum rotational speed for increasing the delivered volumetric flow of the hydraulic medium when the rotational speed of the at least one hydraulic pump of the hydraulic device is equal to or greater than the minimum rotational speed of the at least one hydraulic pump of the hydraulic device and the rotational speed of the further hydraulic pump is equal to or greater than the minimum rotational speed of the further hydraulic pump.

2. The method according to claim 1, wherein the at least one hydraulic pump comprises a single hydraulic pump, the single hydraulic pump has a minimum rotational speed for providing a minimum delivered volumetric flow, wherein when reaching the predetermined delivered volumetric flow which is greater than the minimum delivered volumetric flow of the single hydraulic pump the rotational speed of the single hydraulic pump is equal to or greater than the minimum rotational speed of the single hydraulic pump and the rotational speed of the further hydraulic pump is equal to or greater than the minimum rotational speed of the further hydraulic pump.

3. The method according to claim 1, wherein the at least one hydraulic pump comprises a plurality of hydraulic pumps which are connected to one another, wherein each of the plurality of hydraulic pumps has a minimum rotational speed for providing a respective minimum delivered volumetric flow of the respective hydraulic pump, wherein when the further hydraulic pump is connected the rotational speeds of the plurality of hydraulic pumps of the hydraulic device are respectively equal to or greater than the respective minimum rotational speed of the respective hydraulic pump of the hydraulic device and the rotational speed of the further hydraulic pump is equal to or greater than the minimum rotational speed of the further hydraulic pump.

4. The method according to claim 1, wherein the rotational speed of the at least one hydraulic pump of the hydraulic device is reduced when the further hydraulic pump is connected or the rotational speeds of the at least one and further hydraulic pumps of the hydraulic device are reduced when the further hydraulic pump is connected.

5. The method according to claim 4, wherein the reduced rotational speed of the at least one hydraulic pump or the reduced rotational speeds of the at least one and further hydraulic pumps is determined as a function of an available delivered volume of the further hydraulic pump and an additional delivered volume for increasing the delivered volumetric flow.

6. The method according to claim 4, wherein when the rotational speed of the at least one hydraulic pump of the hydraulic device is reduced or when the rotational speeds of the at least one and further hydraulic pumps of the hydraulic device are reduced, a constant delivered volumetric flow is provided when the further hydraulic pump (is connected.

7. The method according to claim 1, wherein a functional speed of the hydraulic system is brought about by the hydraulic system, wherein the functional speed of the hydraulic system remains constant when the further hydraulic pump is connected.

8. A method for operating a hydraulic system, according to claim 1,
wherein a delivered volumetric flow of the hydraulic medium is provided for moving at least one hydraulic cylinder by a hydraulic device which has the at least one hydraulic pump and which at a minimum rotational speed of the at least one hydraulic pump provides a minimum delivered volumetric flow of the hydraulic medium,
wherein when reaching a predetermined delivered volumetric flow which is greater than the minimum delivered volumetric flow of the hydraulic device, the further hydraulic pump having a minimum rotational speed is disconnected for reducing the delivered volumetric flow of the hydraulic medium when the rotational speed of the at least one hydraulic pump of the hydraulic device is equal to or greater than the minimum rotational speed of the at least one hydraulic pump of the hydraulic device.

9. The method according to claim 8, wherein the at least one hydraulic pump comprises a single hydraulic pump, wherein the single hydraulic pump has a minimum rotational speed for providing a minimum delivered volumetric flow, wherein when reaching the predetermined delivered volumetric flow which is greater than the minimum delivered volumetric flow of the single hydraulic pump the rotational speed of the single hydraulic pump is equal to or greater than the minimum rotational speed of the single hydraulic pump.

10. The method according to claim 9, wherein the at least one hydraulic pump comprises a plurality of hydraulic pumps which are connected to one another, wherein each of the plurality of hydraulic pumps has a minimum rotational speed for providing a respective minimum delivered volumetric flow of the respective hydraulic pump, wherein when the further hydraulic pump is disconnected the rotational speeds of the plurality of hydraulic pumps of the hydraulic device are respectively equal to or greater than the respective minimum rotational speed of the respective hydraulic pump of the hydraulic device.

11. The method according to one of claim 8, wherein the rotational speed of the at least one hydraulic pump of the hydraulic device is increased when the further hydraulic pump is disconnected or the rotational speeds of the at least one hydraulic pump of the hydraulic device are increased when the further hydraulic pump is disconnected.

12. The method according to claim 11, wherein the increased rotational speed of the at least one hydraulic pump or the increased rotational speed of the at least one hydraulic pump is determined as a function of a reducible delivered volume of the further hydraulic pump and a smaller delivered volume for reducing the delivered volumetric flow.

13. The method according to claim 11, wherein when the rotational speed of the at least one hydraulic pump of the hydraulic device is increased or when the rotational speed of the at least one hydraulic pump of the hydraulic device are increased, a constant delivered volumetric flow is provided when the further hydraulic pump is disconnected.

14. The method according to claim 8, wherein a functional speed of the hydraulic system is brought about by the hydraulic system, wherein the functional speed of the hydraulic system remains constant when the further hydraulic pump is disconnected.

15. The method according to claim 1, wherein the minimum rotational speed of the at least one hydraulic pump of the hydraulic device and the minimum rotational speed of the further hydraulic pump are dependent on the respective efficiency characteristics of the respective hydraulic pump.

16. The method according to one of claim 1, wherein the at least one hydraulic pump and the further hydraulic pump are controlled independently of one another by a controller comprising hardware.

17. An industrial truck comprising:
a controller comprising hardware, the controller being configured to:
provide a delivered volumetric flow of a hydraulic medium for moving at least one hydraulic cylinder by a hydraulic device which has at least one hydraulic pump and which at a minimum rotational speed of the at least one hydraulic pump provides a minimum delivered volumetric flow of a hydraulic medium,
wherein when reaching a predetermined delivered volumetric flow which is greater than the minimum delivered volumetric flow of the hydraulic device, connect a further hydraulic pump having a minimum rotational speed for increasing the delivered volumetric flow of the hydraulic medium when the rotational speed of the at least one hydraulic pump of the hydraulic device is equal to or greater than the minimum rotational speed of the at least one hydraulic pump of the hydraulic device and the rotational speed of the further hydraulic pump is equal to or greater than the minimum rotational speed of the further hydraulic pump.

18. The industrial truck according to claim 17, further comprising:
a lifting mast configured to lift a load;
wherein the at least one and further hydraulics pumps are configured to operate the lifting mast to lift the load.

19. The method according to one of claim 18, wherein a lifting speed of the hydraulic system is brought about by the hydraulic system, wherein the lifting speed of the hydraulic system remains constant when the further hydraulic pump is connected.

20. A processing apparatus comprising:
a controller comprising hardware, the controller being configured to:
provide a delivered volumetric flow of a hydraulic medium for moving at least one hydraulic cylinder by a hydraulic device which has at least one hydraulic pump and which at a minimum rotational speed of the at least one hydraulic pump provides a minimum delivered volumetric flow of a hydraulic medium,
wherein when reaching a predetermined delivered volumetric flow which is greater than the minimum delivered volumetric flow of the hydraulic device, connect a further hydraulic pump having a minimum rotational speed for increasing the delivered volumetric flow of the hydraulic medium when the rotational speed of the at least one hydraulic pump of the hydraulic device is equal to or greater than the minimum rotational speed of the at least one hydraulic pump of the hydraulic device and the rotational speed of the further hydraulic pump is equal to or greater than the minimum rotational speed of the further hydraulic pump.
